(19) United States
(12) Patent Application Publication
(10) Pub. No.: US 2020/0183535 A1
(43) Pub. Date: Jun. 11, 2020

(54) LIGHT EMITTING ELEMENT MATRIX PANEL INPUT DEVICE

(71) Applicant: GENERALPLUS TECHNOLOGY INC., Hsinchu City (TW)

(72) Inventor: Li Sheng LO, Hsinchu City (TW)

(21) Appl. No.: 16/704,647

(22) Filed: Dec. 5, 2019

(30) Foreign Application Priority Data
Dec. 7, 2018 (TW) 107144075

(51) Int. Cl. G06F 3/042

(52) U.S. Cl. CPC G06F 3/0428; G06F 3/03545

(57) ABSTRACT

In a light emitting element matrix panel input device, a light emitting element matrix panel includes M×N light emitting elements, and includes M first axis input terminals and N second axis input terminals. A light emitting element matrix panel input method includes: simultaneously outputting M first axis coordinate signals to the corresponding M first axis input terminals in a first axis signal time period, wherein the first axis coordinate signals carry different first axis digital information; simultaneously outputting N second axis coordinate signals to the corresponding N second axis input terminals in a second axis signal time period, wherein the second axis coordinate signals carry different second axis digital information; and illuminating the (I, J) light emitting element when a receiving device is close to the (I, J) light emitting element, and the I^{th} first axis digital information and the J^{th} second axis digital information are decoded.

### CROSS-REFERENCE TO RELATED APPLICATIONS

This application claims priority of No. 107144075 filed in Taiwan R.O.C. on Dec. 7, 2018 under 35 USC 119, the entire content of which is hereby incorporated by reference.

### BACKGROUND OF THE INVENTION

### Field of the Invention

The invention relates to the technology of a light emitting diode panel, and more particularly to a light emitting element matrix panel input device.

### Description of the Related Art

A light emitting diode writing board generally includes an N×M light emitting diode matrix and an optical sensing pen working therewith. If a pattern needs to be inputted, then the N×M light emitting diode matrix outputs optical signals in a column by column and row by row manner. FIG. 1 is a schematic view showing a coordinate detection method of a conventional light emitting diode writing board. Referring to FIG. 1 firstly, an equivalent circuit of an optical sensing pen 11 shown in FIG. 1 includes a photoresistor 101, wherein the resistance of the photoresistor directly relates to the intensity of the light. When the light intensity increases, the resistance decreases. When the light intensity decreases, the resistance decreases. It is assumed that the optical sensing pen 11 is configured in the third row and the second column.

The N×M light emitting diode matrix generally performs scanning from the first row to the N^{th} row in a row by row and one by one manner. Light emitting starts from the first light emitting diode in the first row to the M^{th} light emitting diode in the first row. Next, light emitting starts from the first light emitting diode in the second row to the M^{th} light emitting diode in the second row until the M^{th} light emitting diode in the N^{th} row emits light. It is assumed that the optical sensing pen 11 is configured in the third row and the second column. When scanning is performed, in a row by row manner, to the third row and the second column, the photoresistor 101 of the optical sensing pen 11 receives light and has the decreased resistance, and a sensing voltage Vrx rises significantly. Therefore, the light emitting diode writing board can determine the coordinates (3, 2) and control the light emitting diode at the coordinates (3, 2) to emit light.

The above-mentioned solution has the drawback that only one light emitting diode can emit light (outputting a detection signal) within a specific time period. Therefore, the panel has the low brightness and the low response speed. For the N×M light emitting diode matrix, the brightness is equal to only 1/(n×m). Meanwhile, a relatively stable distance between a receiving end and the LED panel is needed to receive the optical signal. Furthermore, because the brightness is insufficient, the ambient light often provides interference to cause the poor reception. In addition, the optical sensing pen 11 must be connected to the light emitting diode matrix panel, so that the light emitting diode matrix panel can determine which point is scanned by the optical sensing pen 11 when the optical sensing pen 11 receives the optical signal.

### BRIEF SUMMARY OF THE INVENTION

An objective of the invention is to provide a light emitting element matrix panel input device for directly obtaining coordinates by transmitting different signals in each of the light emitting diodes, and then decoding the signals by the receiving end.

In view of this, the invention provides a light emitting element matrix panel input device including a light emitting element matrix, a control circuit and a receiving device. The light emitting element matrix includes M×N light emitting elements, and includes M first axis input terminals and N second axis input terminals. The control circuit is coupled to the M first axis input terminals and the N second axis input terminals. The receiving device is coupled to the control circuit. In a first axis signal time period, the control circuit simultaneously outputs M first axis coordinate signals to the M first axis input terminals, wherein the first axis coordinate signals carry different first axis digital information. In a second axis signal time period, the control circuit simultaneously outputs N second axis coordinate signals to the corresponding N second axis input terminals, wherein the second axis coordinate signals carry different second axis digital information. When the receiving device is close to the (I, J) light emitting element, and the I^{th} first axis digital information and the J^{th} second axis digital information are decoded, the control circuit illuminates the (I, J) light emitting element, where M, N, I and J are natural numbers, I is smaller than or equal to M, and J is smaller than or equal to N.

In the light emitting element matrix panel input device according to preferred embodiment of the present invention, the M×N light emitting elements are light emitting diodes. In a preferred embodiment of the present invention, each of the M first axis coordinate signals comprises a header field, a data field and a trailer field, wherein: when data in the data field is a first logic, a pulse interval of the M first axis coordinate signals is equal to a first interval; and when the data in the data field is a second logic, the pulse interval of the M first axis coordinate signals is equal to a second interval, and an idle symbol interval of the header field and the trailer field is equal to a third interval, wherein the first interval, the second interval and the third interval are unequal to one another, wherein pulse widths of the M first axis coordinate signals change according to brightness of the corresponding light emitting element.

In the light emitting element matrix panel input device according to preferred embodiment of the present invention, each of the N second axis coordinate signals comprises a header field, a data field and a trailer field, wherein: when data in the data field is a first logic, a pulse interval of the N second axis coordinate signals is equal to a first interval; and when the data in the data field is a second logic, the pulse interval of the M first axis coordinate signals is equal to a second interval, and an idle symbol interval of the header field and the trailer field is equal to a third interval, wherein the first interval, the second interval and the third interval are unequal to one another, wherein pulse widths of the N second axis coordinate signals change according to brightness of the corresponding light emitting element.

In the light emitting element matrix panel input device according to preferred embodiment of the present invention, each of the M first axis coordinate signals comprises a data field and a trailer field, wherein a pulse interval of a first logic of the data field is defined as a first interval, a pulse interval of a second logic of the data field is defined as a second interval, and an interval of an idle symbol of the trailer field is defined as a third interval, wherein pulse widths of the M first axis coordinate signals change according to brightness of the corresponding light emitting element, wherein counts of idle symbols of the trailer field are adjusted according to a time length of the data field, so that the first axis coordinate signals have consistent lengths.

In the light emitting element matrix panel input device according to preferred embodiment of the present invention, the receiving device includes a photodiode, an amplifier circuit and an edge detecting circuit. The photodiode includes an anode and a cathode, wherein the anode of the photodiode is coupled to a common voltage. The amplifier circuit includes an input terminal and an output terminal, wherein the input terminal of the amplifier circuit is coupled to the cathode of the photodiode. The edge detecting circuit is coupled to the output terminal of the amplifier circuit, and detects a time interval of pulses outputted from the amplifier circuit to decode coordinate information.

The invention further provides a light emitting element matrix panel input device including a light emitting element panel, a control circuit and a receiving device. The light emitting element panel includes N light emitting elements. The control circuit has N input/output ports respectively and is correspondingly coupled to the N light emitting elements. The receiving device coupled to the control circuit. In a detection period, the control circuit simultaneously outputs N coordinate signals to the N light emitting elements, wherein the Ith coordinate signal carries I^{th} digital information. When the receiving device is close to the J^{th} specific light emitting element, and the J^{th} digital information is decoded, the control circuit illuminates the Jth light emitting element, where N, I and J are natural numbers, I is smaller than or equal to N, and J is smaller than or equal to N.

The invention further provides a light emitting element matrix panel input device, including a light emitting element matrix, a control circuit and a receiving device. The light emitting element matrix includes M×N light emitting elements, and comprising M first axis input terminals and N second axis input terminals. The control circuit coupled to the M first axis input terminals and the N second axis input terminals. The receiving device coupled to the control circuit. The signal time period is divided into N scan signal time periods, and in each of the scan signal time periods, the control circuit simultaneously outputs M first axis coordinate signals to the M first axis input terminals, wherein the first axis coordinate signals carry different first axis digital information. When the receiving device is close to the (I, J) light emitting element, and the Ith first axis digital information is decoded in the Jth first axis signal time period, the control circuit illuminates the (I, J) light emitting element, where M, N, I and J are natural numbers, I is smaller than or equal to M, and J is smaller than or equal to N.

In the light emitting element matrix panel input device according to preferred embodiment of the present invention, each of the M first axis coordinate signals comprises a data field and a trailer field, wherein a pulse interval of a first logic of the data field is defined as a first interval, a pulse interval of a second logic of the data field is defined as a second interval, and an interval of an idle symbol of the trailer field is defined as a third interval, wherein pulse widths of the M first axis coordinate signals change according to brightness of the corresponding light emitting element, wherein counts of idle symbols of the trailer field are adjusted according to a time length of the data field, so that the first axis coordinate signals have consistent lengths.

The essence of the invention is to load different information into the light driving signal given to the light emitting diode and to decode the information by the receiving device. Therefore, multiple light emitting elements of the light emitting element matrix panel, which originally need to be operated in a time-division and one by one manner, can perform the illuminating operations simultaneously. In addition to shortening of the sensing time, it is also possible to increase the average brightness of the light emitting element matrix panel. Furthermore, the light receiving device needs not to be connected to the light emitting element matrix panel in a wired manner, and can be connected to the light emitting element matrix panel in a wired or wireless manner.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

FIG. 1 is a schematic view showing a coordinate detection method of a conventional light emitting diode writing board.

FIG. 2 is a circuit diagram showing a wireless charging transmitter according to a preferred embodiment of the invention.

FIG. 3 is a schematic view showing operations of a light emitting element matrix panel input device according to a preferred embodiment of the invention.

FIG. 4A shows an encoding waveform chart for the light emitting element matrix panel input device according to a preferred embodiment of the invention.

FIG. 4B shows an encoding waveform chart for the light emitting element matrix panel input device according to a preferred embodiment of the invention.

FIG. 5 is a circuit diagram showing a receiving device 203 of the light emitting element matrix panel input device according to a preferred embodiment of the invention.

FIG. 6 is a circuit diagram showing the receiving device 203 of the light emitting element matrix panel input device according to a preferred embodiment of the invention.

FIG. 7 is a circuit diagram showing the light emitting element matrix panel input device according to a preferred embodiment of the invention.

FIG. 8A is a schematic view showing the operations of the light emitting element matrix panel input device according to a preferred embodiment of the invention.

FIG. 8B is an encoding waveform chart showing the light emitting element matrix panel input device according to a preferred embodiment of the invention.

FIG. 9 is a circuit diagram showing a receiving device 703 of the light emitting element matrix panel input device according to a preferred embodiment of the invention.

FIG. 10 is a circuit diagram showing the receiving device 703 of the light emitting element matrix panel input device according to a preferred embodiment of the invention.

FIG. 11 is a circuit diagram showing the light emitting element matrix panel input device according to a preferred embodiment of the invention.

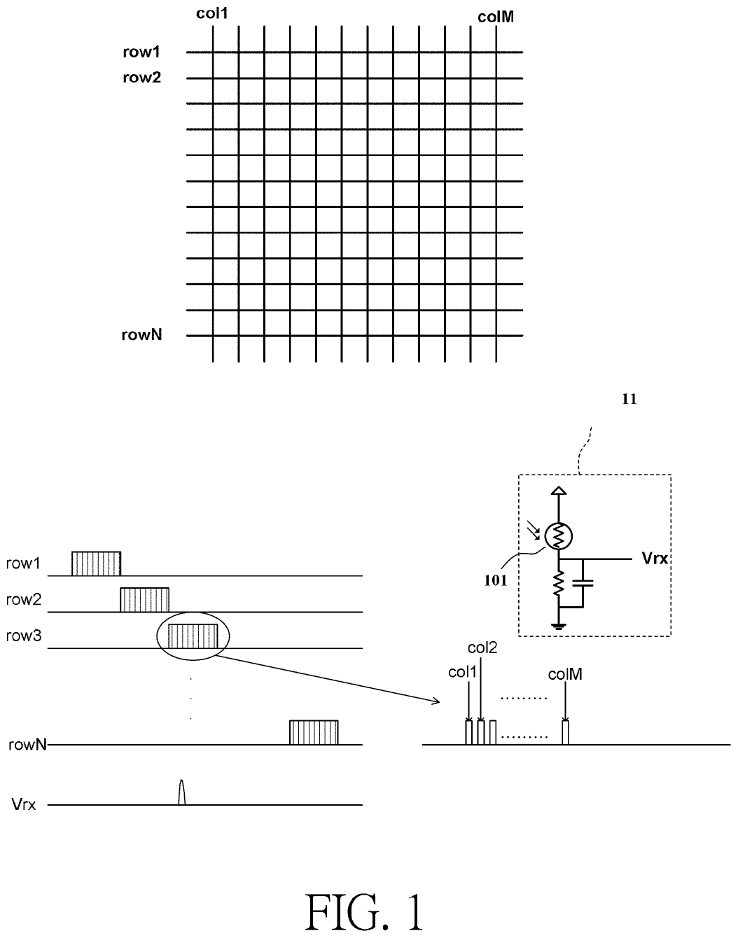

### DETAILED DESCRIPTION OF THE INVENTION

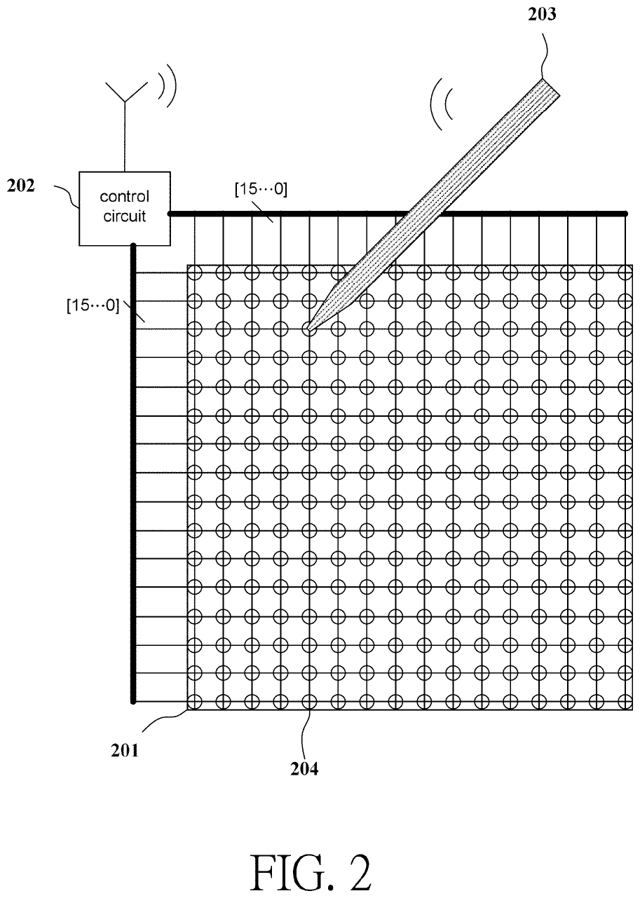

FIG. 2 is a circuit diagram showing a light emitting element matrix panel input device according to a preferred embodiment of the invention. Referring to FIG. 2, the light emitting element matrix panel input device includes a light emitting element matrix 201, a control circuit 202 and a receiving device 203. In this exemplified embodiment, the light emitting element matrix 201 has 16×16 light emitting elements 204, and includes 16 Y-axis input terminals and 16 X-axis input terminals. The control circuit 202 can be implemented by using a microprocessor in conjunction with a peripheral circuit. The control circuit 202 totally has 36 input/output ports coupled to the 16 Y-axis input terminals and the 16 X-axis input terminals, respectively.

In this exemplified embodiment, the receiving device 203 is a pen-shaped light receiver having a pen head with an element capable of receiving light. The receiving device 203 is implemented in a wireless form in this embodiment, and communicates with the control circuit 202 by way of wireless signal transmitting. In other words, the control circuit 202 also includes a wireless receiver. Although the receiving device 203 is wirelessly connected to the control circuit 202 in this embodiment, those skilled in the art should know that the receiving device 203 can also be connected to the control circuit 202 in a wired manner.

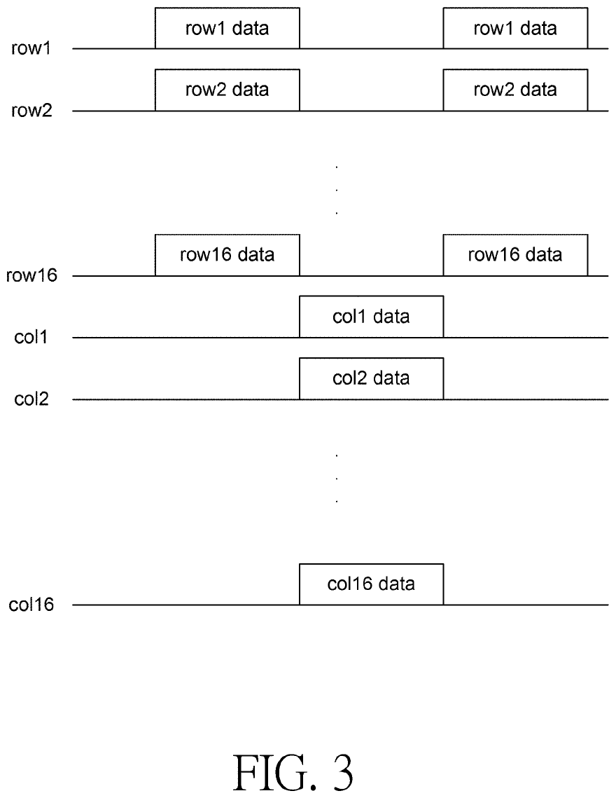

FIG. 3 is a schematic view showing operations of a light emitting element matrix panel input device according to a preferred embodiment of the invention. Please refer to FIG. 3, compared with the control mode of the prior art, in which the elements are illuminated one by one to sense the light-emitting spots, the scan time period is only divided into the Y-axis signal time period and the X-axis signal time period in this embodiment. In the Y-axis signal (row signal) time period, all 16 Y-axis (row) input terminals are driven simultaneously. However, different Y-axis driving signals are respectively given to the Y-axis (row) input terminals. In the X-axis signal (column signal) time period, all 16 X-axis (column) input terminals are driven simultaneously. However, different X-axis driving signals are respectively given to the X-axis input terminals.

If a photosensitive member of the receiving device 203 is close to the third Y-axis light emitting element and the fifth X-axis light emitting element of the light emitting element matrix 201, then the receiving device 203 receives a Y-axis signal corresponding to the third Y-axis light emitting element in the Y-axis signal time period. The receiving device 203 obtains Y-axis information of the currently directed light emitting element by way of decoding. Similarly, the receiving device 203 receives an X-axis signal corresponding to the fifth X-axis light emitting element in the X-axis signal time period. The receiving device 203 obtains X-axis information of the currently directed light emitting element by way of decoding. Thus, the receiving device 203 wirelessly transmits the decoded position information (3, 5) to the control circuit 202, and the control circuit 202 controls the light emitting element at the coordinates (3, 5) to illuminate according to the above-mentioned decoded result.

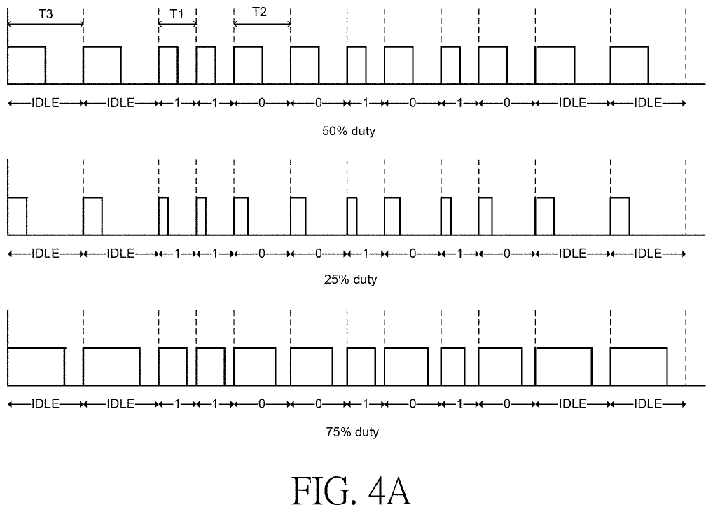

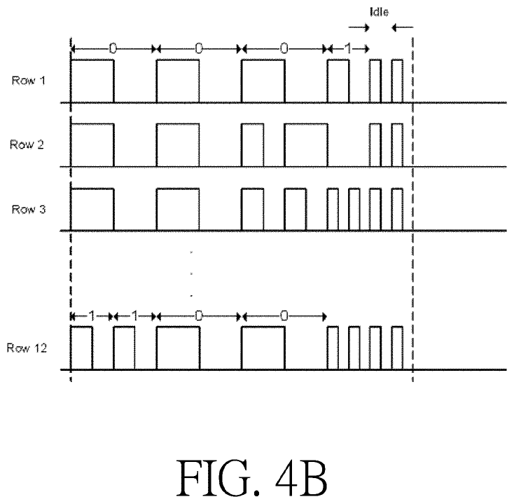

FIG. 4A shows an encoding waveform chart for the light emitting element matrix panel input device according to a preferred embodiment of the invention. Referring to FIG. 4A of this embodiment, the encoding is to control the brightness based on the PWM width, but to determine the transmitted logic based on the time length at the edge of the signal. The packet format of the signal includes, for example, a header field, a trailer field and a data field, wherein both the header field and the trailer field are two idle symbols for synchronization. The data field is an 8-bit sequence data and can provide 128 position identifications. If it is similar to the above-mentioned embodiment having only 16 rows, then only 4 bits of data are needed. The bit length of the above-mentioned data field can be modified according to panel size requirements, and detailed descriptions thereof will be omitted here.

When the transmitted data is logic 1, the first time interval T1 with the shorter time interval represents the logic 1. When the transmitted data is logic 0, the second time interval T2 with the longer time interval represents the logic 0. When the transmitted data is an idle symbol, it is represented by the third time interval T3 with the longest time interval. As shown in FIG. 4A, whether the brightness is low (25% duty cycle), medium (50% duty cycle) or high (75% duty cycle), only the width of the pulse is changed, the time interval is not changed with the change of the brightness, and the time interval is changed only with the change of the transmitted data. So, the brightness and the data do not affect each other. Therefore, the receiving device 203 only needs to detect the time interval between the edges so that the data can be decoded.

FIG. 4B shows an encoding waveform chart for the light emitting element matrix panel input device according to a preferred embodiment of the invention. Referring to FIG. 4B of this embodiment, the portion of the header field is cancelled, only the trailer field is left, and a ratio of time lengths of the logic 1, the logic 0 and the idle symbol is defined as 4:2:1. Also, the length of the trailer field is not fixed, and is used to adjust the time length. For example, the data of the first row signal row1 is 0001, and the time length of the data field of the signal is equal to 4+4+4+2=14 units; and the data of the third row signal row3 is 0011, and the time length of the data field of the signal is equal to 4+4+2+2=12 units. In this embodiment, two idle symbols are added to the trailer field of the first row signal row1, and four idle symbols are added to the trailer field of the third row signal row3 to make the lengths of the signals become consistent.

FIG. 5 is a circuit diagram showing a receiving device 203 of the light emitting element matrix panel input device according to a preferred embodiment of the invention. Referring to FIG. 5, the receiving device 203 includes a photodiode 501, an amplifier circuit 502, an edge detecting circuit 503 and a wireless transmitting circuit 504. The photodiode 501 has an anode coupled to a common voltage, and a cathode coupled to an input terminal of the amplifier circuit 502. An output terminal of the amplifier circuit 502 is coupled to the edge detecting circuit 503. The edge detecting circuit 503 detects a time interval of pulses outputted from the amplifier circuit to decode the coordinate information. Thereafter, the wireless transmitting circuit 504 returns the decoded result to the control circuit 202, and the control circuit 202 illuminates the corresponding light emitting element again according to the decoded result. In this embodiment, the amplifier circuit 502 amplifies and converts the optical signal into a pulse using three amplifiers and the peripheral resistors and capacitors to perform filtering and comparing.

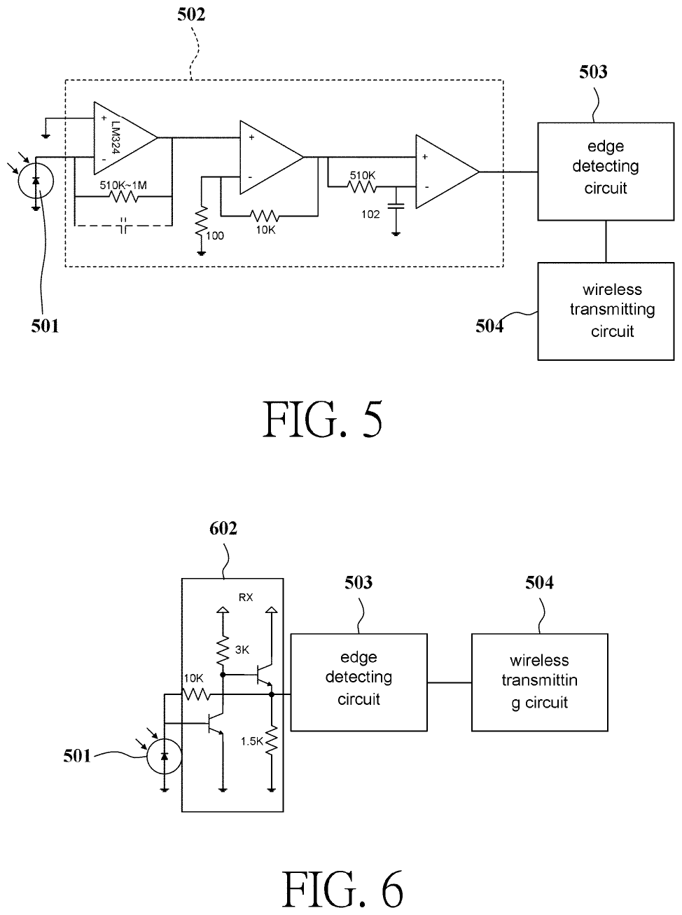

FIG. 6 is a circuit diagram showing the receiving device 203 of the light emitting element matrix panel input device according to a preferred embodiment of the invention. Referring to FIG. 6, the receiving device 203 includes a photodiode 501, an amplifier circuit 602, an edge detecting circuit 503 and a wireless transmitting circuit 504. In this embodiment, the amplifier circuit 602 is implemented by two transistors and three resistors. The anode of the photodiode 501 is coupled to a common voltage, and the cathode of the photodiode 501 is coupled to the input terminal (base) of the amplifier circuit 502 (transistor). The output terminal of the amplifier circuit 502 is coupled to the edge detecting circuit 503. The edge detecting circuit 503 detects the time interval of the pulses outputted by the amplifier circuit 502 to decode the coordinate information. Then, the wireless transmitting circuit 504 returns the decoded result to the control circuit 202, and the control circuit 202 illuminates the corresponding light emitting element again according to the decoded result.

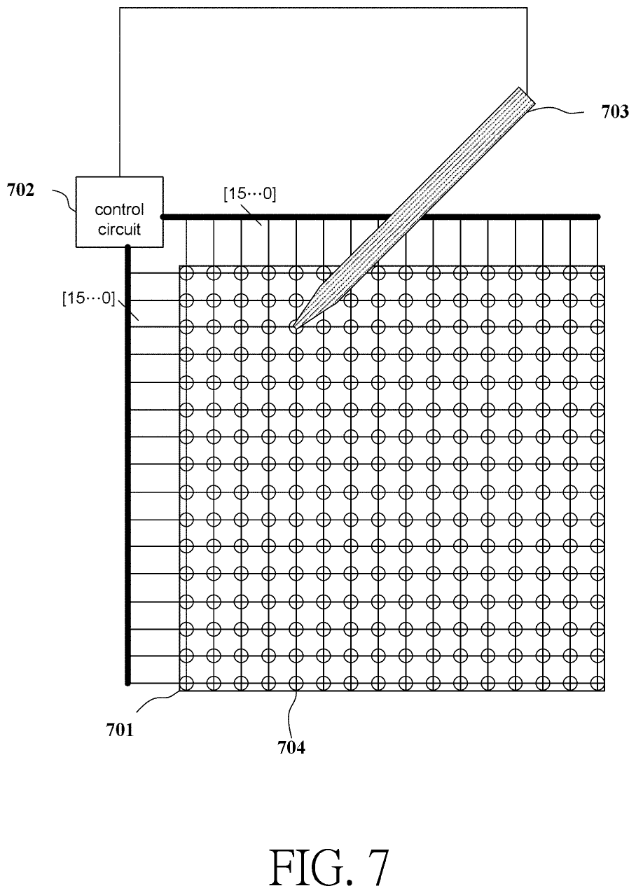

FIG. 7 is a circuit diagram showing the light emitting element matrix panel input device according to a preferred embodiment of the invention. Please refer to FIG. 7, the light emitting element matrix panel input device includes a light emitting element matrix 701, a control circuit 702 and a receiving device 703. In this exemplified embodiment, the light emitting element matrix 701 has 16×16 light emitting diodes 704. The control circuit 702 totally has 32 input/output ports coupled to the 16 Y-axis input terminals and the 16 X-axis input terminals, respectively. The difference between the embodiments of FIGS. 7 and 2 resides in that the receiving device 703 is electrically connected to the control circuit 702 in a wired manner. Although the receiving device 703 still receives the encoded signal, only the pulses of the encoded signals need to be restored without decoding. So, the control circuit 702 can perform the decoding operation similar to the edge detection.

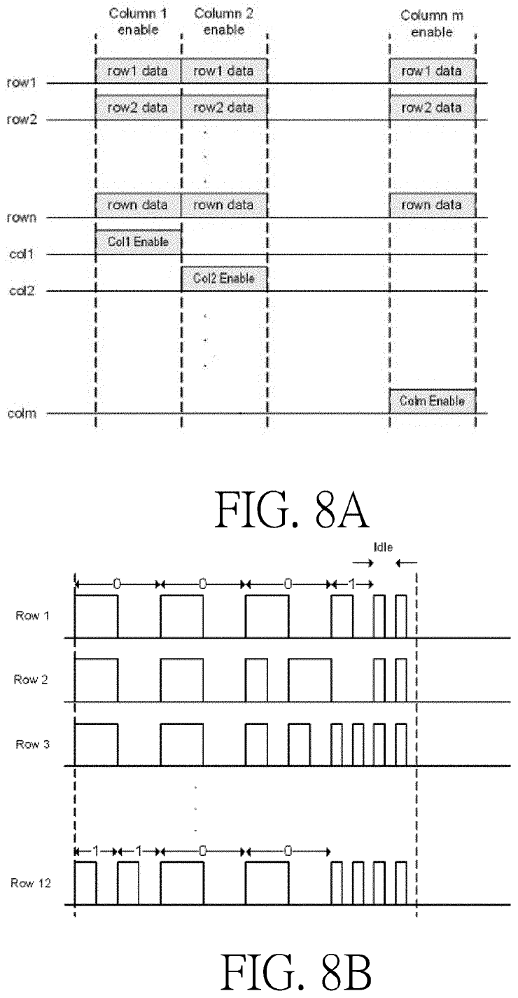

FIG. 8A is a schematic view showing the operations of the light emitting element matrix panel input device according to a preferred embodiment of the invention. Referring to FIG. 8A, the way of scanning is adopted in this embodiment. That is, one column is enabled and all the 16 rows of data in the column are outputted at each time. So, the scan time period for the whole surface at a time is divided into 16 columns of scan time periods, and 16 rows of data are outputted correspondingly and simultaneously in each column of scan time period.

FIG. 8B is an encoding waveform chart showing the light emitting element matrix panel input device according to a preferred embodiment of the invention. Please refer to FIGS. 8B and 4B, the portion of the header field is canceled in this embodiment similarly, only the trailer field is left, and a ratio of time lengths of the logic 1, the logic 0 and the idle symbol is defined as 4:2:1. Also, the length of the trailer field is not fixed, and is used to adjust the time length. For example, the data of the first row signal row1 is 0001, the time length of the data field of the signal is equal to 4+4+4+2=14 units; and the data of the third row signal row3 is 0011, and the time length of the data field of the signal is equal to 4+4+2+2=12 units. In this embodiment, two idle symbols are added to the trailer field of the first row signal row1, and four idle symbols are added to the trailer field of the third row signal row3 to make the lengths of the signals become consistent.

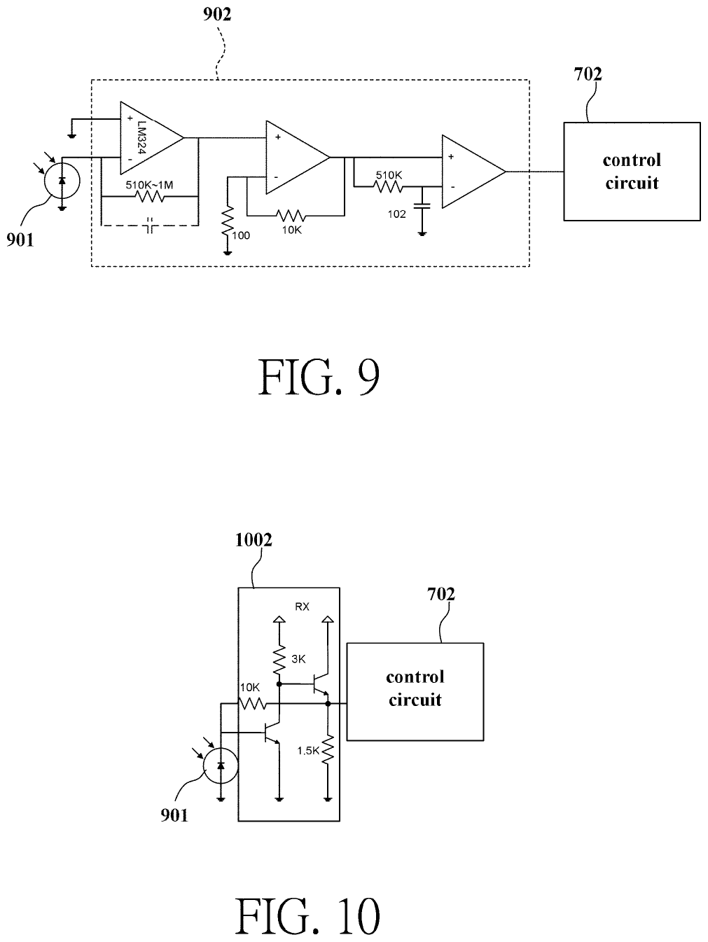

FIG. 9 is a circuit diagram showing a receiving device 703 of the light emitting element matrix panel input device according to a preferred embodiment of the invention. Please refer to FIGS. 5 and 9. As mentioned hereinabove, because the edge detection mechanism can be performed by the control circuit 702, the receiving device 703 in this embodiment only includes a photodiode 901 and an amplifier circuit 902 without the edge detecting circuit 503 and a wireless transmitting circuit 504 of FIG. 5. FIG. 10 is a circuit diagram showing the receiving device 703 of the light emitting element matrix panel input device according to a preferred embodiment of the invention. Please refer to FIGS. 10 and 6 simultaneously. Similarly, because the edge detection mechanism can be performed by the control circuit 702, the receiving device 703 in this embodiment only includes a photodiode 901 and an amplifier circuit 1002 without the edge detecting circuit 503 and a wireless transmitting circuit 504 of FIG. 6.

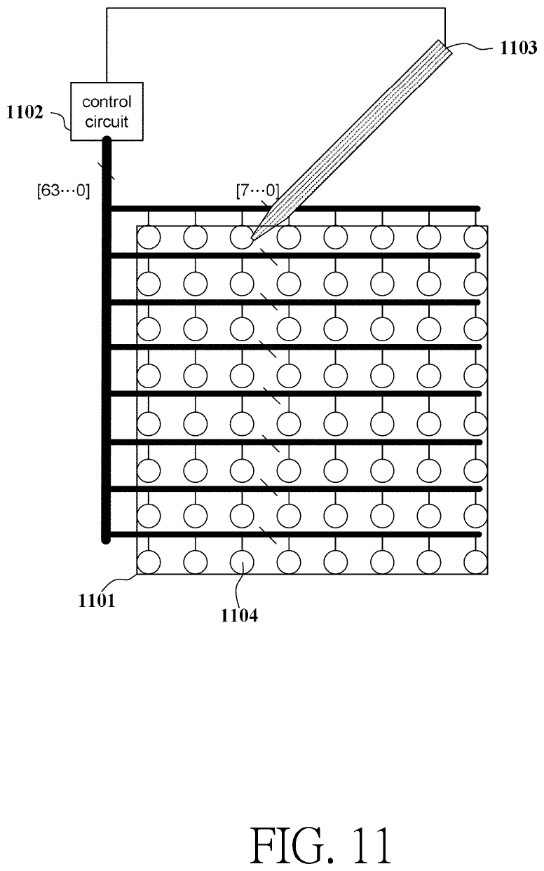

FIG. 11 is a circuit diagram showing the light emitting element matrix panel input device according to a preferred embodiment of the invention. Referring to FIG. 11, the light emitting element matrix panel input device includes a light emitting element matrix 1101, a control circuit 1102 and a receiving device 1103. In this exemplified embodiment, the light emitting element matrix 1101 has 8×8 light emitting diodes 1104. The control circuit 1102 has 64 input/output ports (the figure totally shows 64 ports with [63 . . . 0]), which are coupled to anodes of the above-mentioned 64 light emitting diodes 1104 (each row in the figure shows 8 different traces with [7 . . . 0], and the traces are respectively connected to the above-mentioned 64 traces). The cathode of the light emitting diode 1104 is grounded (not shown in figure). It can be obtained that the input/output ports of the control circuit 1102 are respectively and independently coupled to the corresponding light emitting diodes 1104. That is, the control circuit 1102 can independently control each light emitting diode 1104.

When panel input scanning is being performed, the control circuit 1102 can adopt the method of FIG. 4A, in which 64 different signals are simultaneously given to the above-mentioned 64 light emitting diodes 1104, and a receiving device 1003 only needs to decode the received optical signal to obtain the coordinate information of the corresponding light emitting diode 1104. When the receiving device 1103 returns the coordinate information of the light emitting diode to the control circuit 1102, the control circuit 1102 can illuminate the corresponding light emitting diode 1104 according to the information.

In the above-mentioned embodiment, the receiving device of FIG. 9 or 10 can be used as the receiving device 1103. In addition, when the receiving device 1103 is a wireless receiving device, the receiving device of FIG. 5 or 6 can also be adopted. The invention is not restricted thereto. In addition, although the above-mentioned embodiment provides an example, in which a light-emitting diode is used as a light-emitting element, those skilled in the art should know that the micro light emitting diode (micro LED), the organic light emitter diode (OLED), and even a general light bulb can be used as the light emitting element of the embodiment of the invention. So the invention is not limited to the above-mentioned light emitting diode. In addition, the signal encoding method in FIG. 4A or 4B or any other signal encoding method can also be adopted. Similarly, the invention is not limited to the above-mentioned encoding method.

In summary, the essence of the invention is to load different information into the light driving signal given to the light emitting diode and to decode the information by the receiving device. Therefore, multiple light emitting elements of the light emitting element matrix panel, which originally need to be operated in a time-division and one by one manner, can perform the illuminating operations simultaneously. In addition to shortening of the sensing time, it is also possible to increase the average brightness of the light emitting element matrix panel. Furthermore, the light receiving device needs not to be connected to the light emitting element matrix panel in a wired manner, and can be connected to the light emitting element matrix panel in a wired or wireless manner.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A light emitting element matrix panel input device, comprising:
a light emitting element matrix comprising M×N light emitting elements, and comprising M first axis input terminals and N second axis input terminals;
a control circuit coupled to the M first axis input terminals and the N second axis input terminals; and
a receiving device coupled to the control circuit;
wherein in a first axis signal time period, the control circuit simultaneously outputs M first axis coordinate signals to the M first axis input terminals, wherein the first axis coordinate signals carry different first axis digital information;
wherein in a second axis signal time period, the control circuit simultaneously outputs N second axis coordinate signals to the corresponding N second axis input terminals, wherein the second axis coordinate signals carry different second axis digital information;
wherein when the receiving device is close to the (I, J) light emitting element, and the I^{th} first axis digital information and the J^{th} second axis digital information are decoded, the control circuit illuminates the (I, J) light emitting element,
where M, N, I and J are natural numbers, I is smaller than or equal to M, and J is smaller than or equal to N.

2. The light emitting element matrix panel input device according to claim 1, wherein the M×N light emitting elements are light emitting diodes.

3. The light emitting element matrix panel input device according to claim 1, wherein each of the M first axis coordinate signals comprises a header field, a data field and a trailer field, wherein: when data in the data field is a first logic, a pulse interval of the M first axis coordinate signals is equal to a first interval; and when the data in the data field is a second logic, the pulse interval of the M first axis coordinate signals is equal to a second interval, and an idle symbol interval of the header field and the trailer field is equal to a third interval, wherein the first interval, the second interval and the third interval are unequal to one another, wherein pulse widths of the M first axis coordinate signals change according to brightness of the corresponding light emitting element.

4. The light emitting element matrix panel input device according to claim 1, wherein each of the N second axis coordinate signals comprises a header field, a data field and a trailer field, wherein: when data in the data field is a first logic, a pulse interval of the N second axis coordinate signals is equal to a first interval; and when the data in the data field is a second logic, the pulse interval of the M first axis coordinate signals is equal to a second interval, and an idle symbol interval of the header field and the trailer field is equal to a third interval, wherein the first interval, the second interval and the third interval are unequal to one another, wherein pulse widths of the N second axis coordinate signals change according to brightness of the corresponding light emitting element.

5. The light emitting element matrix panel input device according to claim 1, wherein the receiving device comprises:
a photodiode comprising an anode and a cathode, wherein the anode of the photodiode is coupled to a common voltage; and
an amplifier circuit comprising an input terminal and an output terminal, wherein the input terminal of the amplifier circuit is coupled to the cathode of the photodiode.

6. The light emitting element matrix panel input device according to claim 5, wherein the receiving device further comprises:
an edge detecting circuit, which is coupled to the output terminal of the amplifier circuit, and detects a time interval of pulses outputted from the amplifier circuit to decode coordinate information.

7. A light emitting element matrix panel input device, comprising:
a light emitting element panel comprising N light emitting elements;
a control circuit having N input/output ports respectively and correspondingly coupled to the N light emitting elements;
a receiving device coupled to the control circuit;
wherein in a detection period, the control circuit simultaneously outputs N coordinate signals to the N light emitting elements, wherein the I^{th} coordinate signal carries I^{th} digital information;
wherein when the receiving device is close to the J^{th} specific light emitting element, and the J^{th} digital information is decoded, the control circuit illuminates the J^{th} light emitting element,
where N, I and J are natural numbers, I is smaller than or equal to N, and J is smaller than or equal to N.

8. The light emitting element matrix panel input device according to claim 7, wherein the N light emitting elements are light emitting diodes.

9. The light emitting element matrix panel input device according to claim 7, wherein each of the N coordinate signals comprises a header field, a data field and a trailer field, wherein: when data in the data field is a first logic, a pulse interval of the N coordinate signals is equal to a first interval; and when the data in the data field is a second logic, the pulse interval of the N coordinate signals is equal to a second interval, and an idle symbol interval of the header field and the trailer field is equal to a third interval, wherein the first interval, the second interval and the third interval are unequal to one another, wherein pulse widths of the N coordinate signals change according to brightness of the corresponding light emitting element.

10. The light emitting element matrix panel input device according to claim 7, wherein the receiving device comprises:
a photodiode comprising an anode and a cathode, wherein the anode of the photodiode is coupled to a common voltage;
an amplifier circuit comprising an input terminal and an output terminal, wherein the input terminal of the amplifier circuit is coupled to the cathode of the photodiode; and
an edge detecting circuit, which is coupled to the output terminal of the amplifier circuit, and detects a time interval of pulses outputted from the amplifier circuit to decode coordinate information.

11. A light emitting element matrix panel input device, comprising:
a light emitting element matrix comprising M×N light emitting elements, and comprising M first axis input terminals and N second axis input terminals;
a control circuit coupled to the M first axis input terminals and the N second axis input terminals;
a receiving device coupled to the control circuit;
wherein a signal time period is divided into N scan signal time periods, and in each of the scan signal time periods, the control circuit simultaneously outputs M first axis coordinate signals to the M first axis input terminals, wherein the first axis coordinate signals carry different first axis digital information;
wherein when the receiving device is close to the (I, J) light emitting element, and the I^{th} first axis digital information is decoded in the J^{th} first axis signal time period, the control circuit illuminates the (I, J) light emitting element,
where M, N, I and J are natural numbers, I is smaller than or equal to M, and J is smaller than or equal to N.

12. The light emitting element matrix panel input device according to claim 11, wherein the M×N light emitting elements are light emitting diodes.

13. The light emitting element matrix panel input device according to claim 11, wherein each of the M first axis coordinate signals comprises a header field, a data field and a trailer field, wherein when data in the data field is a first logic, a pulse interval of the M first axis coordinate signals is equal to a first interval, when the data in the data field is a second logic, the pulse interval of the M first axis coordinate signals is equal to a second interval, and an idle symbol interval of the header field and the trailer field is equal to a third interval, wherein the first interval, the second interval and the third interval are unequal to one another, wherein pulse widths of the M first axis coordinate signals change according to brightness of the corresponding light emitting element.

14. The light emitting element matrix panel input device according to claim 11, wherein each of the M first axis coordinate signals comprises a data field and a trailer field, wherein a pulse interval of a first logic of the data field is defined as a first interval, a pulse interval of a second logic of the data field is defined as a second interval, and an interval of an idle symbol of the trailer field is defined as a third interval, wherein pulse widths of the M first axis coordinate signals change according to brightness of the corresponding light emitting element, wherein counts of idle symbols of the trailer field are adjusted according to a time length of the data field, so that the first axis coordinate signals have consistent lengths.

15. The light emitting element matrix panel input device according to claim 11, wherein the receiving device comprises:
a photodiode comprising an anode and a cathode, wherein the anode of the photodiode is coupled to a common voltage;
an amplifier circuit comprising an input terminal and an output terminal, wherein the input terminal of the amplifier circuit is coupled to the cathode of the photodiode; and
an edge detecting circuit, which is coupled to the output terminal of the amplifier circuit, and detects a time interval of pulses outputted from the amplifier circuit to decode coordinate information.
